(19) United States
(12) Patent Application Publication
(10) Pub. No.: US 2010/0042794 A1
(43) Pub. Date: Feb. 18, 2010

(54) DATA PROTECTION SYSTEM AND METHOD

(76) Inventors: Wen-Sen Tsai, Jhubei City (TW); Chih-Chieh Peng, Jhubei City (TW)

Correspondence Address: SINORICA, LLC, 2275 Research Blvd., Suite 500, ROCKVILLE, MD, 20850, US

(21) Appl. No.: 12/404,524

(22) Filed: Mar. 16, 2009

(30) Foreign Application Priority Data
Aug. 15, 2008 (TW) 097131097
Aug. 15, 2008 (TW) 097214644

(51) Int. Cl. G06F 12/16; G06F 12/00; G06F 12/02

(52) U.S. Cl. 711/162; 711/170; 711/112; 711/E12.001; 711/E12.002; 711/E12.103; 711/163

(57) ABSTRACT

A data protection system and method apply to a computer device. The computer device links to a data protection system. The data protection system contains or links to at least two storage units. The data protection method partitions all the storage units into two blocks, and one block functions as an active memory zone, and another block functions as a backup memory zone. In each cycle of data backup, a portion of the operating storage units are backuped to the storage units in the backup memory zone. Then, the role of the storage units that have been backuped and the role of the storage units that have backuped data interchange with the active memory zone and the backup memory zone respectively having original numbers of the storage units. When one storage unit malfunctions, data can be retrieved from another storage unit and written back to the malfunctioning storage unit. In the present invention, the storage units alternately backup data. Thereby, the storage units are averagely used, and the service lives thereof are prolonged, and data intactness is guaranteed. In the present invention, a mirror-technology is used to backup data and maintain the correctness and security of data. Therefore, the present invention can provide an effective data protection method.

### BACKGROUND OF THE INVENTION

1. Field of the Invention

The present invention relates to a data protection system and method, particularly to a data protection system and method using a mirror-technology to periodically backup data and keep security and intactness of data.

2. Description of the Related Art

The global popularization of the Internet and computers greatly shortens the distance between people and realizes such as SOHO (Small Office/Home Office), distance education, and videoconference. However, the Internet and computers also bring about problems, such as computer virus infection and disc damage, and important data may thus vanish. Further, frequently or long-time using the same hard drive may also cause loss or damage of data in the hard drive. Therefore, preserving data is a very important task in using a computer.

Accordingly, the present invention proposes a data protection system and method to solve the above-mentioned problems.

### SUMMARY OF THE INVENTION

The primary objective of the present invention is to provide a data protection system and method, which periodically and alternately backup data in different storage devices to preserve data and use all the storage devices averagely to prolong the service lives of storage devices.

Another objective of the present invention is to provide a data protection system and method, which use a mirror-technology to keep security and intactness of data and provides users with an effective data protection measure.

The present invention proposes a data protection system and method, which apply to a computer device. The computer device has a data protection system. The data protection system contains or links to at least two storage units. The computer device assigns at least one storage unit of the data protection system to be a first memory zone, and assigns at least one storage unit of the data protection system to be a second memory zone. When the first memory zone is used as the active memory zone, the second memory zone is used as the backup memory zone. When the second memory zone is used as the active memory zone, the first memory zone is used as the backup memory zone. When the first memory zone is used as the active memory zone, the data of at least one arbitrary storage unit A of the first memory zone is backuped to the storage units B of the second memory zone after an interval of time. During the following usage of the computer device, the unbackuped storage units of the first memory zone and the storage units B of the second memory zone are used as the active memory zone; the storage units A of the first memory zone and the unused storage units of the second memory zone are used as the backup memory zone. Then, the computer device waits for a timing to perform another cycle of data backup procedures mentioned above.

The present invention uses a mirror technology to backup data, wherein identical data is written into one or more storage units to guarantee the security of data. When one storage unit malfunctions, data can be retrieved from another storage unit and written back to the malfunctioning storage unit. In the present invention, the storage units backup data periodically and alternately, and the storage units are thus averagely used. Therefore, the present invention can prolong the service lives of storage units and guarantee the intactness and security of data. Therefore, the present invention can provide an effective data protection method and solve the conventional problem that the data in storage units is damaged or lost by frequently or long-time using the same storage units.

Below, the embodiments are described in detail in cooperation with the attached drawings to make easily understood the objectives, technical contents, characteristics and accomplishments of the present invention.

### BRIEF DESCRIPTION OF THE DRAWINGS

FIG. 1 is a block diagram schematically the architecture of the system according to one embodiment of the present invention;

FIG. 2 is a flowchart of the method according to another embodiment of the present invention;

FIGS. 3-6 are diagram schematically showing the system according to yet another embodiment of the present invention;

FIGS. 7-9 are diagram schematically showing the system according to still another embodiment of the present invention; and

FIG. 10 is a block diagram schematically the architecture of the system according to a further embodiment of the present invention.

### DETAILED DESCRIPTION OF THE INVENTION

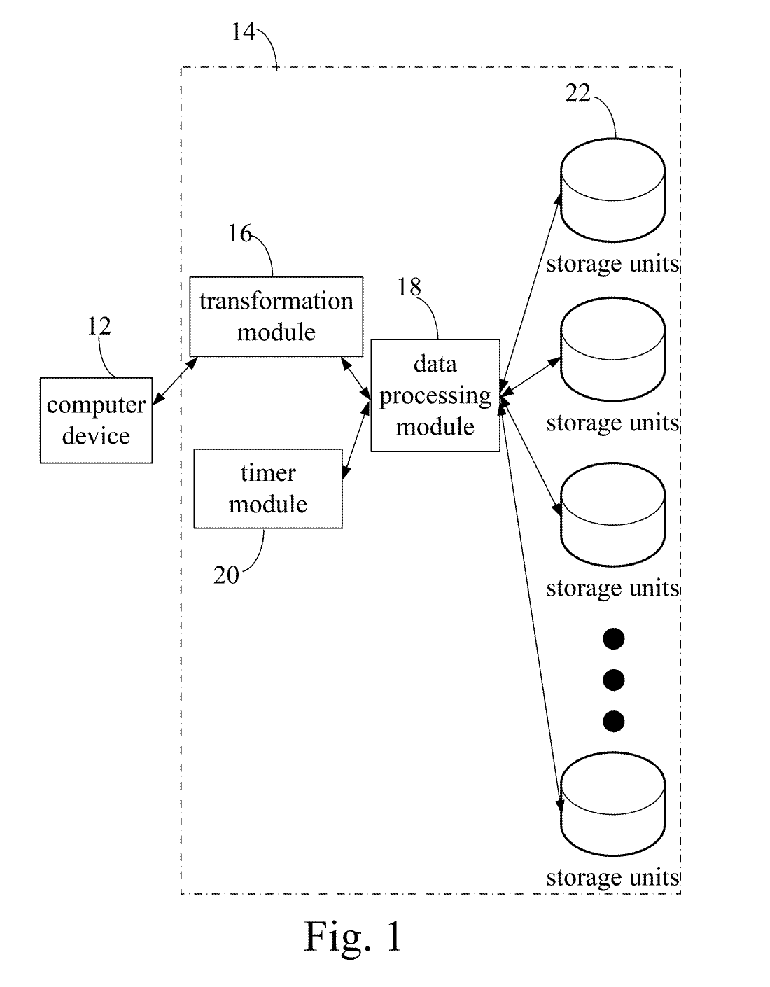

Refer to FIG. 1. The present invention applies to a computer device 12, and the data protection method of the present invention is realized by a data protection system 14. The data protection system 14 comprises a transformation module 16, a data processing module 18, and at least two storage units 22. The transformation module 16 links to the computer device 12.

The data processing module 18 links to the transformation module 16, at least two storage units 22 and a timer module 20. The computer device 12 uses the transformation module 16 and the data processing module 18 to read or delete the data in the storage devices 22. The transformation module 16 transforms the data format used in the data protection system 14 into the format suitable to the computer device 12. The computer device 12 uses the timer module 20 to statistically calculate backup timing and arranges the data backup sequence according to the backup timing. The storage units 22 are multimedia storage devices, such as SSD (Solid State Disc) or traditional hard drives. In this embodiment, SSD is used.

In this embodiment, the timer module 20 and the at least two storage units 22 are built inside the data protection system 14. In fact, the present invention does not demand that the storage units 22 should be built inside the data protection system 14 but only requires that the storage units 22 be electrically coupled to the data protection system 14. In this embodiment, one storage unit 22 is an individual SSD or an individual traditional hard drive. In fact, a hard drive can be divided into many partitions, and each partition is used as one storage unit 22, in the present invention.

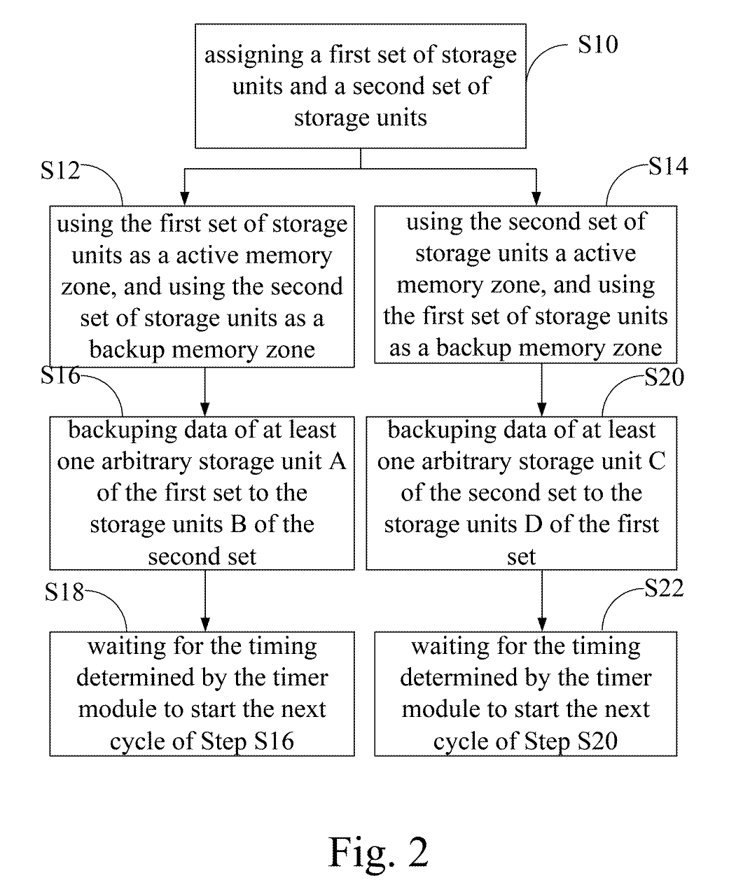

The abovementioned process that the computer device controls the backup sequence of the storage units is exactly the spirit of the data protection method disclosed in the present invention. Below, the method of the present invention is described in cooperation with FIG. 2.

In Step S10, the computer device assigns at least one storage unit of the data protection system to be a first memory zone, and assigns at least one storage unit of the data protection system to be a second memory zone.

Next, the process proceeds to Step S12 or Step S14. In Step S12, the first memory zone is used as the active memory zone, and the second memory zone is used as the backup memory zone. In Step S14, the second memory zone is used as the active memory zone, and the first memory zone is used as the backup memory zone. The computer device can access the active memory zone in real time, but the computer device cannot access the backup memory zone at the same time.

After Step S12, the process proceeds to Step S16. In Step S16, the data of at least one arbitrary storage unit A of the first memory zone is backuped to the storage units B of the second memory zone after an interval of time. During the following usage of the computer device, the unbackuped storage units of the first memory zone and the storage units B of the second memory zone are used as the active memory zone; the storage units A of the first memory zone and the unused storage units of the second memory zone are used as the backup memory zone. The quantity of the storage units A is identical to the quantity of the storage units B. Data backup is realized with a mirror-technology. Next, the process proceeds to Step S18. In Step S18, the computer device waits for the timing determined by the timer module to start the next cycle of Step S16.

After Step S14, the process proceeds to Step S20. In Step S20, the data of at least one arbitrary storage unit C of the second memory zone is backuped to the storage units D of the first memory zone after an interval of time. During the following usage of the computer device, the unbackuped storage units of the second memory zone and the storage units D of the first memory zone are used as the active memory zone; the storage units C of the second memory zone and the unused storage units of the first memory zone are used as the backup memory zone. The quantity of the storage units C is identical to the quantity of the storage units D. Data backup is realized with a mirror-technology. Next, the process proceeds to Step S22. In Step S22, the computer device waits for the timing determined by the timer module to start the next cycle of Step S20.

Suppose that the quantity of the storage units of the data protection system of the present invention is K, and that the quantity of the storage units of the first memory zone is M, and that the quantity of the storage units of the second memory zone is N. K, M and N have to satisfy the equation K=M+N, wherein K, M and N are positive integers, and K is greater than or equal to 2, and M or N is greater than or equal to 1.

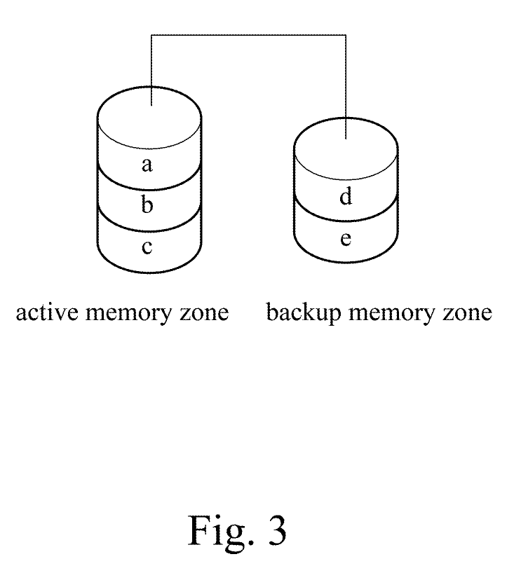

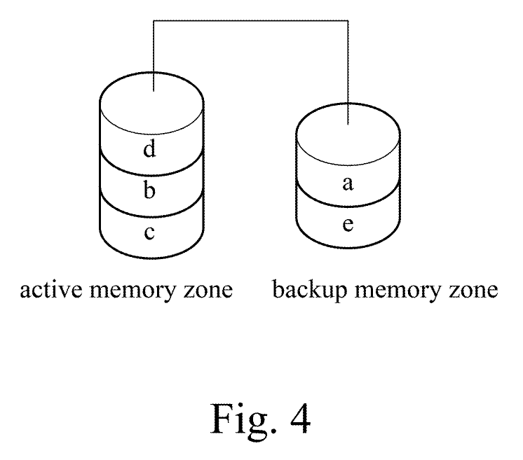

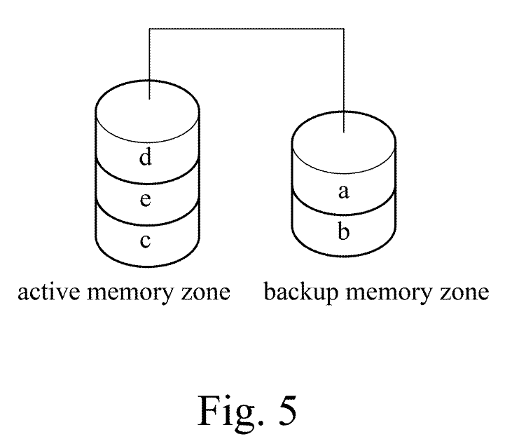

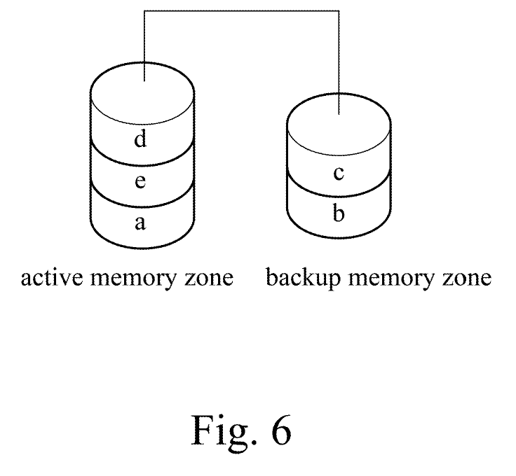

Based on the abovementioned principle, several embodiments are introduced below. Refer to FIG. 3. The first memory zone consists of three SSDs a, b and c and functions as the active memory zone. The second memory zone consists of two SSDs d and e and functions as the backup memory zone. Suppose that the timer module informs the computer device to backup data once per month, and that data of one SSD is backuped with a mirror-technology in each time of backup. Refer to FIG. 4. After backup, the data of the SSD a is backuped to the SSD d, and the SSD d replaces the SSD a to function as the active storage unit, and the SSD a is used as the backup storage unit. Refer to FIG. 5 and FIG. 6. In the following cycles of backups, different storage units exchange to function as the active and backup storage units. Such a design uses all the storage units averagely and thus prolongs the service lives of the storage units.

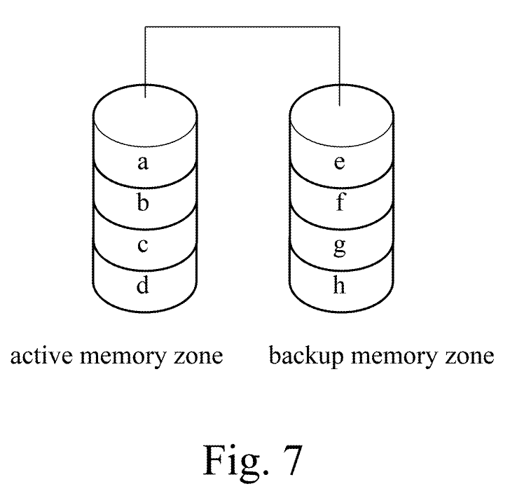

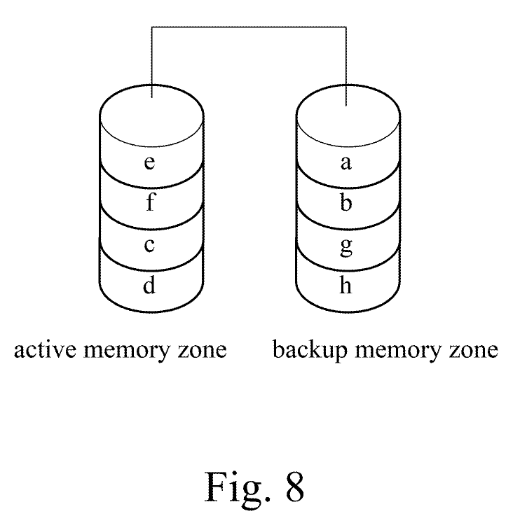

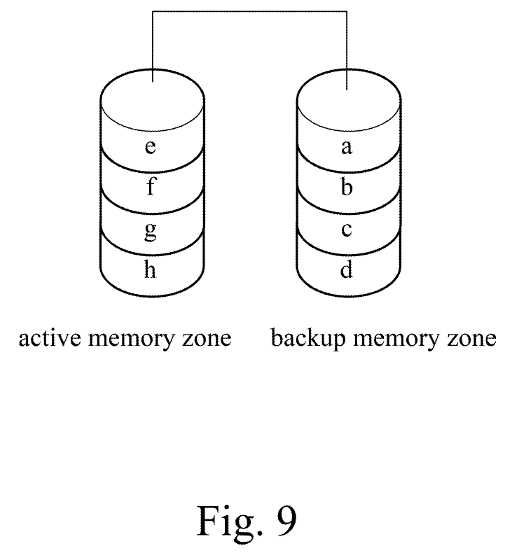

Refer to FIG. 7 for another embodiment. The first memory zone consists of four SSDs a, b, c and d and functions as the active memory zone. The second memory zone consists of four SSDs e, f, g, and h and functions as the backup memory zone. Suppose that the timer module informs the computer device to backup data once per month, and that data of two SSDs is backuped with a mirror-technology in each time of backup. Refer to FIG. 8. After backup, the data of the SSDs a and b is backuped to the SSDs e and f, and the SSDs e and f replace the SSDs a and b to function as the active storage units, and the SSD a and b are used as the backup storage units. The next cycle of backup is shown in FIG. 9. In fact, all the storage units are not moved in the abovementioned process. What are changed are the states of the storage units, i.e. the state of being the active storage units or the state of being the backup storage units.

After a storage unit has been frequently used for a long time, data of the storage unit may be lost or damaged. The mirror-technology constantly writes the completely identical data to one or more storage units to persistently backup the data. If one storage unit malfunctions, the data can be read from another storage unit and written back to the malfunctioning storage unit. In the present invention, the storage units periodically exchange to backup data, whereby the storage units are averagely used, and the service lives thereof are prolonged. Further, the present invention uses the mirror-technology to keep security and intactness of data and provides users with an effective data protection method.

The present invention may also apply to a single storage device (ex: hard drive [symbol] SSD), wherein the single storage device is split into a first partition and a second partition. The architecture of the system and the process of the method of this embodiment are similar to those mentioned above and will not repeat herein.

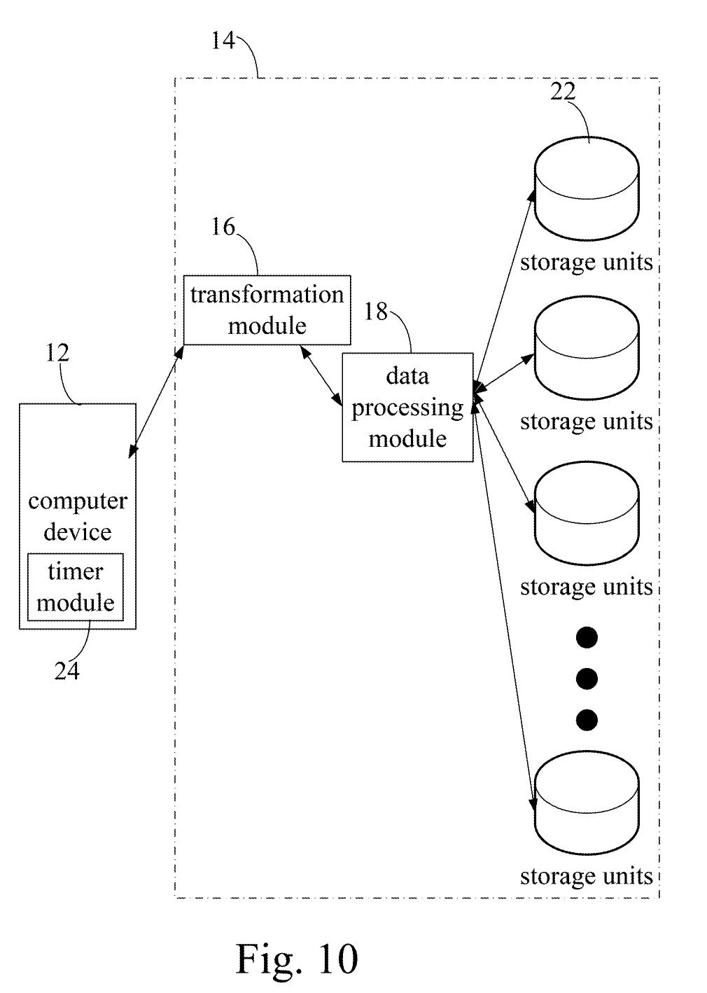

Refer to FIG. 10 for another embodiment. Different from the system shown in FIG. 1, the system shown in FIG. 10 uses a timer module 24 arranged inside the computer device to calculate the backup timing. The method for FIG. 10 is similar to the method for FIG. 1 and will not repeat herein.

The embodiments described above are only to exemplify the present invention but not to limit the scope of the present invention. Therefore, any equivalent modification or variation according to the shapes, structures, characteristics and spirits of the present invention is to be also included within the scope of the present invention.

What is claimed is:

1. A data protection method, which applies to a computer device that comprises a data protection system having at least two storage units or linking to at least two storage units, comprising steps:
Step A: said computer device assigning at least one of said storage units to be a first memory zone containing a plurality of subzones, and assigning at least one of said storage units, which have not been assigned to be said first memory zone yet, to be a second memory zone containing a plurality of subzones;
Step B: when said first memory zone is used as an active memory zone, using said second memory zone as a backup memory zone; when said second memory zone is used as an active memory zone, using said first memory zone as a backup memory zone;
Step C: when said first memory zone is used as said active memory zone, backuping data of at least one arbitrary said subzone of said first memory zone to at least one arbitrary said subzone of said second memory zone after an interval of time;
Step D: then using said subzones, which are not backuped in said Step C, of said first memory zone, and said subzones, which have backuped said data in said Step C, of said second memory zone, as an active memory zone; using said subzones, which have been backuped in said Step C, of said first memory zone, and said subzones, which do not backup said data in said Step C, of said second memory zone, as a backup memory zone; and
Step E: said computer device waiting for a next timing to perform said Step C again.

2. The data protection method according to claim 1, wherein a count of said storage units of said data protection system is equal to a sum of a count of said subzones of said first memory zone and a count of said subzones of said second memory zone.

3. The data protection method according to claim 1, wherein data is backuped with a mirror-technology.

4. The data protection method according to claim 1, wherein said storage units of said data protection system are multimedia storage devices, SSD (Solid State Disc), or traditional hard disc drives.

5. The data protection method according to claim 1 further comprising a transformation module arranged inside said data protection system transforming a data format used in said data protection system into a format compatible with said computer device.

6. A data protection method, which applies to a computer device that comprises a data protection system having at least two storage units or linking to at least two storage units, comprising:
Step A: said computer device partitioning said storage units into a first storage region containing a plurality of subregions and a second storage region containing a plurality of subregions;
Step B: when said first storage region is used as an active storage region, using said second storage region as a backup storage region; when using said second storage region as an active storage region, using said first storage region as a backup storage region;
Step C: when said first storage region is used as an active storage region, backuping data of at least one arbitrary said subregion of said first storage region to at least one arbitrary said subregion of said second storage region after an interval of time;
Step D: then using said subregions, which are not backuped in said Step C, of said first storage region, and said subregions, which have backuped said data in said Step C, of said second storage region, as an active storage region; using said subregions, which have been backuped in said Step C, of said first region, and said subregions, which do not backup said data in said Step C, of said second storage region as a backup storage device; and
Step E: said computer device waiting for a next timing to perform said Step C again.

7. The data protection method according to claim 6, wherein a count of said storage units of said data protection system is equal to a sum of a count of said subregions of said first storage region and a count of said subregions of said second storage region.

8. The data protection method according to claim 6, wherein data is backuped with a mirror-technology.

9. The data protection method according to claim 6, wherein said storage units of said data protection system are multimedia storage devices, SSD (Solid State Disc), or traditional hard disc drives.

10. The data protection method according to claim 6 further comprising a transformation module arranged inside said data protection system transforming a data format used in said data protection system into a format compatible with said computer device.

11. A data protection method, which applies to a computer device that connects with a data protection system having at least two storage units or linking to at least two storage units, wherein said data protection method partitions all said storage units into two blocks, and one said block functions as an active memory zone, and another said block functions as a backup memory zone, and wherein a portion of said storage units that are operating are backuped to said storage units in said backup memory zone in each cycle of data backup, and then a role of said storage units that have been backuped and a role of said storage units that have backuped data are exchanged with said active memory zone and said backup memory zone respectively having original numbers of said storage units.
